(19) United States
(12) Patent Application Publication
(10) Pub. No.: US 2005/0080718 A1
(43) Pub. Date: Apr. 14, 2005

(54) Systems, methods and computer program products for providing customer sales information

(76) Inventor: Wealthy Desai, Atlanta, GA (US)

Correspondence Address: MYERS BIGEL SIBLEY & SAJOVEC, P.A., P.O. BOX 37428, RALEIGH, NC, 27627, US

(21) Appl. No.: 10/673,751

(22) Filed: Sep. 29, 2003

(51) Int. Cl. G06F 17/60

(52) U.S. Cl. 705/38

(57) ABSTRACT

A method for providing customer sales information includes sending a request for customer sales information associated with a customer from a member of a business organization to a customer sales information processing and communication (CSIPC) server associated with the business organization using a terminal that is remote from the CSIPC server. External credit rating information associated with the customer is retrieved from an external credit rating agency (ECRA) system using the CSIPC server. The ECRA system is not associated with the organization. The customer sales information is sent from the CSIPC server to the terminal. The customer sales information is based on the external credit rating information. Related systems and computer program products are also described.

### FIELD OF THE INVENTION

This invention relates to systems, methods and computer program products for providing information and, more particularly, to systems, methods and computer program products for providing customer sales information relating to a customer or prospective customer.

### BACKGROUND OF THE INVENTION

In the sale of products or services such as advertisements in classified business directories (e.g., Yellow Pages) by a vendor to a customer or prospective customer (hereinafter referred to as “the customer” for brevity), it is often necessary or desirable to have available various information regarding the customer. Such information may include biographical information or information relating to the financial status of the customer. In particular, the vendor may wish to know the creditworthiness of the customer. The customer's creditworthiness may be assessed to determine under what terms the vendor is willing to offer the product/service to the customer. For example, if the customer is a low credit risk, the vendor may be willing to extend a substantially greater value of goods/services to the customer on credit than if the customer is a high credit risk.

A vendor may obtain a credit rating report for a customer from a third party credit rating agency such as Dun & Bradstreet, Equifax, or the like. The vendor may also evaluate the customer's past payment history (including any outstanding balances), if any, with the vendor itself. The vendor may have a customer credit researching function or department that solicits and retrieves credit rating information from third party credit rating agencies and from the vendor's own records and provides these to a representative of the vendor who evaluates the information. Based on the representative's evaluation, the representative may determine terms and conditions under which the vendor is willing to offer the goods/services, such as a classified business directory advertisement, to the customer. Such terms and conditions may include, for example, the total value of products/services the vendor will offer over a period of time without advance payment and/or the amount of down payment required from the customer.

### SUMMARY OF THE INVENTION

According to embodiments of the present invention, a method for providing customer sales information includes sending a request for customer sales information associated with a customer from a member of a business organization to a customer sales information processing and communication (CSIPC) server associated with the business organization using a terminal that is remote from the CSIPC server. External credit rating information associated with the customer is retrieved from an external credit rating agency (ECRA) system using the CSIPC server. The ECRA system is not associated with the organization. The customer sales information is sent from the CSIPC server to the terminal. The customer sales information is based on the external credit rating information.

According to further embodiments of the present invention, a method for providing customer sales information includes sending a request for customer sales information associated with a customer from a member of a business organization to a customer sales information processing and communication (CSIPC) server associated with the business organization using a wireless signal from a wireless communication device. Customer rating information associated with the customer is retrieved using the CSIPC server. The customer sales information is sent to the wireless communication device from the CSIPC server using a wireless signal. The customer sales information is based on the customer rating information.

According to further embodiments of the present invention, a method for providing customer sales information includes sending a request for customer sales information from a member of a business organization to a customer sales information processing and communication (CSIPC) server associated with the business organization using a terminal that is remote from the CSIPC server. The request includes a telephone number. Customer rating information associated with the telephone number is retrieved using the CSIPC server. The customer sales information is sent to the terminal from the CSIPC server. The customer sales information is based on the customer rating information.

According to further embodiments of the present invention, a method for providing customer sales information includes sending a request for customer sales information associated with a customer from a requester to a customer sales information processing and communication (CSIPC) server. Customer rating information associated with the customer is retrieved using the CSIPC server. A sales term is automatically determined using the CSIPC server. The sales term is based on the customer rating information. The sales term is sent to the requester from the CSIPC server.

According to further embodiments of the present invention, a method for providing customer sales information includes sending a request for customer sales information associated with a customer to a customer sales information processing and communication (CSIPC) server associated with a business organization. Internal customer information associated with the customer by the business organization is retrieved from a database of the CSIPC server. External credit rating information associated with the customer is retrieved from an external credit rating agency (ECRA) system. An internal customer rating based on both the external credit rating and the internal customer information is automatically determined using the CSIPC server. The internal customer rating is sent to the requester from the CSIPC server.

According to further embodiments of the present invention, a system for providing customer sales information includes a customer sales information processing and communication (CSIPC) server associated with a business organization. The system further includes a terminal that is remote from the CSIPC server and operable to send a request for customer sales information associated with a customer from a member of the organization to the CSIPC server. The CSIPC server is configured to: receive the request from the terminal; retrieve external credit rating information associated with the customer from an external credit rating agency (ECRA) system, wherein the ECRA system is not associated with the business organization; and send the customer sales information to the terminal. The customer sales information is based on the external credit rating information.

According to further embodiments of the present invention, a system for providing customer sales information includes a customer sales information processing and communication (CSIPC) server associated with a business organization. The system further includes a wireless communication device operable to send a request for customer sales information associated with a customer from a member of the business organization to the CSIPC server using a wireless signal. The CSIPC server is configured to: receive the request from the wireless communication device; retrieve customer rating information associated with the customer using the CSIPC server; and send the customer sales information to the wireless communication device using a wireless signal. The customer sales information is based on the customer rating information.

According to further embodiments of the present invention, a system for providing customer sales information includes a customer sales information processing and communication (CSIPC) server associated with a business organization. The CSIPC server is configured to: receive a request for customer sales information associated with a customer from a member of the business organization using a terminal that is remote from the CSIPC server, the request including a telephone number; retrieve customer rating information associated with the telephone number; and send the customer sales information to the terminal. The customer sales information is based on the customer rating information.

According to further embodiments of the present invention, a system for providing customer sales information includes a customer sales information processing and communication (CSIPC) server. The CSIPC server is configured to: receive a request from a requester for customer sales information associated with a customer; retrieve customer rating information associated with the customer; automatically determine a sales term, wherein the sales term is based on the customer rating information; and send the sales term to the requester.

According to further embodiments of the present invention, a system for providing customer sales information includes a customer sales information processing and communication (CSIPC) server associated with a business organization. The CSIPC server is configured to: receive a request from a requester for customer sales information associated with a customer; retrieve internal customer information associated with the customer by the business organization from a database of the CSIPC server; retrieve external credit rating information associated with the customer from an external credit rating agency (ECRA) system; automatically determine an internal customer rating based on both the external credit rating and the internal customer information; and send the internal customer rating to the requester.

According to further embodiments of the present invention, a computer program product for providing customer sales information includes a computer readable storage medium having computer readable program code embodied in the medium. The computer readable program code includes: computer readable program code configured to send a request for customer sales information associated with a customer from a member of a business organization to a customer sales information processing and communication (CSIPC) server associated with the business organization using a terminal that is remote from the CSIPC server; computer readable program code configured to retrieve external credit rating information associated with the customer from an external credit rating agency (ECRA) system using the CSIPC server, wherein the ECRA system is not associated with the organization; and computer readable program code configured to send the customer sales information from the CSIPC server to the terminal. The customer sales information is based on the external credit rating information.

According to further embodiments of the present invention, a computer program product for providing customer sales information includes a computer readable storage medium having computer readable program code embodied in the medium. The computer readable program code includes: computer readable program code configured to send a request for customer sales information associated with a customer from a member of an organization to a customer sales information processing and communication (CSIPC) server associated with the business organization using a wireless signal from a wireless communication device; computer readable program code configured to retrieve customer rating information associated with the customer using the CSIPC server; and computer readable program code configured to send the customer sales information to the wireless communication device from the CSIPC server using a wireless signal. The customer sales information is based on the customer rating information.

According to further embodiments of the present invention, a computer program product for providing customer sales information includes a computer readable storage medium having computer readable program code embodied in the medium. The computer readable program code includes: computer readable program code configured to receive a request for customer sales information sent from a member of a business organization to a customer sales information processing and communication (CSIPC) server associated with the business organization using a terminal that is remote from the CSIPC server, the request including a telephone number; computer readable program code configured to retrieve customer rating information associated with the telephone number using the CSIPC server; and computer readable program code configured to send the customer sales information to the terminal from the CSIPC server. The customer sales information is based on the customer rating information.

According to further embodiments of the present invention, a computer program product for providing customer sales information includes a computer readable storage medium having computer readable program code embodied in the medium. The computer readable program code includes: computer readable program code configured to receive a request for customer sales information associated with a customer sent from a requester to a customer sales information processing and communication (CSIPC) server; computer readable program code configured to retrieve customer rating information associated with the customer using the CSIPC server; and computer readable program code configured to automatically determine a sales term using the CSIPC server, wherein the sales term is based on the customer rating information; and computer readable program code configured to send the sales term to the requester from the CSIPC server.

According to further embodiments of the present invention, a computer program product for providing customer sales information includes a computer readable storage medium having computer readable program code embodied in the medium. The computer readable program code includes: computer readable program code configured to receive a request for customer sales information associated with a customer sent to a customer sales information processing and communication (CSIPC) server; computer readable program code configured to retrieve internal customer information associated with the customer from a database of the CSIPC server associated with a business organization; computer readable program code configured to retrieve external credit rating information associated with the customer by the business organization from an external credit rating agency (ECRA) system; computer readable program code configured to automatically determine an internal customer rating using the CSIPC server, wherein the internal customer rating is based on both the external credit rating and the internal customer information; and computer readable program code configured to send the internal customer rating to the requester from the CSIPC server.

Other systems, methods, and/or computer program products according to embodiments of the present invention will be or become apparent to one of skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic block diagram illustrating a customer sales information provider system according to embodiments of the present invention;

FIG. 2 is a front plan view of a terminal forming a part of the customer sales information provider system of FIG. 1;

FIG. 3 is a further schematic block diagram illustrating the customer sales information provider system of FIG. 1;

FIG. 4 is a flowchart illustrating operations according to embodiments of the present invention;

FIG. 5 is a further flowchart illustrating operations according to embodiments of the present invention;

FIG. 6 is a further flowchart illustrating operations according to embodiments of the present invention;

FIG. 7 is a further flowchart illustrating operations according to embodiments of the present invention; and

FIG. 8 is a further flowchart illustrating operations according to embodiments of the present invention.

### DETAILED DESCRIPTION OF EMBODIMENTS OF THE INVENTION

The present invention will now be described more fully hereinafter with reference to the accompanying figures, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. In the drawings, layers, regions, or components may be exaggerated for clarity. In the figures, broken lines indicate optional features unless described otherwise. The method steps are not limited to the order in which they are set forth.

As used herein, a “business directory” is a publication including listings for a plurality of businesses or commercial entities. Each listing may include, for example, the name, address and telephone number of the business. In a business directory, it is the business itself that is listed, not merely a product of the business. The listings may be alphabetically or otherwise organized in the business directory. A “classified business directory” is a business directory wherein businesses are categorized or classified according to the relevant category or categories of products or services offered by the respective businesses. An “online business directory” is a business directory accessible via a computer network such as the Internet. A “business directory advertisement” is an advertisement in a business directory. Business directory advertisements may vary in size, location and features, each of which may affect the value and cost of a given business directory advertisement. A business directory advertisement may take the form of a classified listing or otherwise (e.g., an advertisement in a banner or on a cover page of the business directory).

As used herein, “telephone number” means a number corresponding to a unique telephone account so that telephone calls directed to that number will be routed to a telephone address associated with that telephone account.

As will be appreciated by one of skill in the art, the present invention may be embodied as a system, method, data processing system, and/or computer program product. Accordingly, the present invention may take the form of an entirely hardware embodiment, an entirely software embodiment or an embodiment combining software and hardware aspects, which may all generally be referred to herein as a “circuit.” Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as, but not limited to, Java®, Smalltalk or C++. However, the computer program code for carrying out operations of the present invention may also be written in conventional procedural programming languages, such as the “C” programming language. The program code may execute entirely on a computer associated with the system, as a stand-alone software package, partly on the system computer(s), partly on a user's computer and partly on a remote computer or entirely on the remote computer. In the latter scenario, the remote computer may be connected to the system's and/or user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, a Digital Signal Processor (DSP) and/or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer, DSP or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

According to some embodiments of the present invention, a global computer network is used to provide communications between systems and/or devices. According to some embodiments, a preferred global computer network with which the present invention may be utilized is the Internet. The Internet is a worldwide, decentralized network of computers having the ability to communicate with each other. The Internet has gained broad recognition as a viable medium for communicating and for conducting business. The World-Wide Web (Web) is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device, and/or between wireless client/devices and Wireless Application Protocol (WAP) server devices. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), Wireless Markup Language (WML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and which may or may not be geographically dispersed. For example, the Web site of the International Business Machines Corporation (ibm.com) consists of thousands of Web pages and files spread out over multiple Web servers in locations worldwide.

A Web server (also referred to as an HTTP server) is a computer program that utilizes HTTP to serve files that form Web pages to requesting Web clients. Exemplary Web servers include International Business Machines Corporation's family of Lotus Domino® servers, the Apache server (available from apache.org), and Microsoft's Internet Information Server (IIS), available from Microsoft Corporation, Redmond, Wash. A Web client is a requesting program that also utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders within a display screen. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized by users accessing a Web site according to the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects (i.e., activates) a particular hypertext link, a browser running on the user's client device reads and interprets an address, called a Uniform Resource Locator (URL) associated with the hypertext link, connects the browser with a Web server at that address, and makes a request (e.g., an HTTP request) for the file identified in the hypertext link. The Web server then sends the requested file to the client device, which the browser interprets and renders within a display screen.

Systems and methods in accordance with the present invention may be used to provide a requester such as a sales representative with customer sales information associated with a selected customer. The customer sales information may include or be based on an external credit rating (i.e., a credit rating from a third party or external credit rating agency) and/or on an internal credit rating or information (i.e., a credit rating or information derived or collected from a vendor's own records). The customer sales information may include an internal customer rating and/or one or more terms or conditions (hereinafter “the sales term(s)”) relating to the sale of goods or services. The internal customer rating may be based on multiple factors and may be indicative of the predicted credit risk of the customer (e.g., good, neutral, or bad). The sales term(s) may include, for example, a maximum allowable sale or value of goods/services to be offered in a given time period without advance payment, a required down payment, a maximum monthly payment allowed, etc.

According to some embodiments, the goods/services include a business directory advertisement. According to some more particular embodiments, the goods/services include a classified advertisement or listing in a classified business directory. The business directory may be a hard copy and/or online business directory.

In accordance with embodiments of the invention, the foregoing customer sales information may be accessed by the requesting sales representative using a remote terminal. “Remote terminal” as used herein refers to a device that communicates with a system for providing the sales information via a communications network (such as a public switched telephone network (PSTN)) so that the sales representative may be physically remote from the provider system. According to some embodiments, the remote terminal is a wireless communication device so that the sales representative is provided with expanded mobility, versatility and accessibility. According to some embodiments, the remote terminal also communicates with the system for providing the sales information via a computer network (such as the Internet).

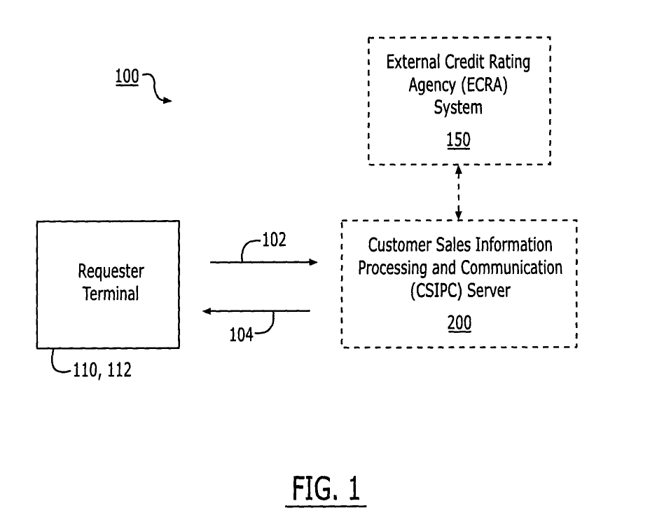

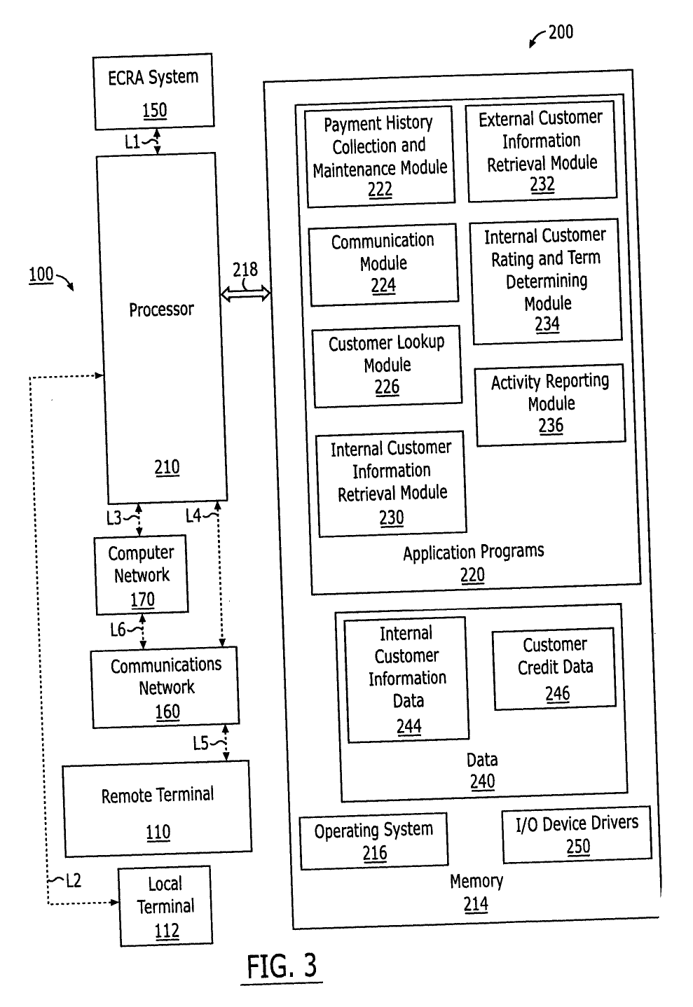

With reference to FIG. 1, a customer sales information provider system 100 according to embodiments of the present invention is shown therein. The system 100 includes a customer sales information processing and communication server 200 (hereinafter “the CSIPC server 200”) and a requester terminal 110 and/or 112 (local or remote, as discussed below with regard to FIG. 3). The CSIPC server 200 may be capable of communicating with an external credit rating agency system 150 (hereinafter “the ECRA system 150”). The CSIPC server 200 may be a plurality of distributed servers.

In use, a requester such as a sales representative may send a request 102 for customer sales information from the requester terminal 110, 112 to the CSIPC server 200. The request may be sent as a text message entered using a keypad or the like of the terminal 110, 112. The CSIPC server 200 is capable of processing the request 102 and sending a response 104 to the requester terminal 110, 112 including the requested customer sales information. The response from the CSIPC server 200 may likewise be sent as a text message that is displayed on a display of the terminal 110, 112.

According to some embodiments, the requester is a member of a business organization and the CSIPC server 200 is associated with or under the control of the business organization. The requester may be a sales representative that is an employee or private contractor of the organization (a vendor), with the CSIPC server 200 being a server controlled by the organization and containing records of the organization. According to some embodiments, the ECRA system 150, by contrast, is not associated with or under the control of the organization.

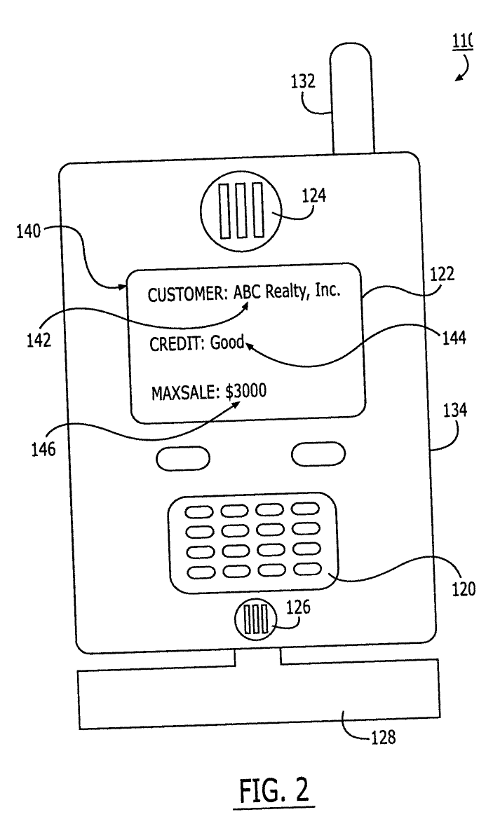

FIG. 2 shows an exemplary requester terminal 110 (as discussed in more detail below) having a display 122. The display 122 shows exemplary text and/or graphics 140 representing the customer sales information. For example, the text shown includes text 142 indicating the customer's identification, text 144 indicating the customer's internal customer rating, and text 146 indicating a sales term (as shown, the maximum sale authorized for this customer is $3000). The sales representative may use the information provided on the display 122 to assist in negotiating the sale of the goods/services to the customer.

The requester terminal may be a remote terminal 110 or a local terminal 112. In either case, the requester terminal may be any suitable pervasive computing and/or communication device. The pervasive computing or communication device can be a radiotelephone, pager, personal computer whether a palm, laptop computer, vehicle-integrated computer or the like. Alternatively, the requester terminal may be a pervasive computing device such as a smartphone, a two-way wireless communicator (such as the Blackberry™ wireless platform) or a PDA.

According to some embodiments, the requester terminal is a wireless communication device used as a remote terminal 110 (also referred to herein as a “wireless remote terminal”) as shown in FIG. 2. According to some embodiments, the wireless remote terminal 110 is a mobile terminal such as a radiotelephone, pager or other suitable handheld communication device. It will be appreciated that the apparatus described for the remote terminal 110 may be employed for the local terminal 112 as well if locally wired to the CSIPC server 200.

With reference to FIG. 2, the exemplary remote terminal 110 may be configured as shown therein in accordance with embodiments of the present invention. However, the remote terminal 110 may be a device of a type and configuration different than that illustrated in the figures.

As illustrated in FIG. 2, the remote terminal 110 is a mobile wireless communication device such as a handheld radiotelephone or pager. As used herein, the term “wireless communication device” may include: a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, and/or calendar; and a conventional laptop, a two-way wireless communicator (such as the Blackberry™ wireless platform) and/or palmtop receiver or other appliance that includes a radiotelephone transceiver.

The wireless remote terminal 110 may include a processor and a suitable power supply. A wireless transceiver, a radiotelephone antenna 132, a keypad 120, a display 140, a speaker 124, a microphone 126, and one or more peripheral devices 128 are operatively coupled to the processor. In conventional manner, the transceiver may include a transmitter circuit and a receiver circuit, which respectively transmit outgoing radio frequency signals to a base station operatively coupled to a communications network (e.g., the communications network 160 as described below) and receive incoming radio frequency signals from the base station via the antenna 132. The radio frequency signals transmitted between the remote terminal 110 and the base station may comprise both traffic and control signals (e.g., paging signals/messages for incoming calls), which are used to establish and maintain communication with another party or destination. According to some embodiments, the remote terminal 110 is capable of placing voice calls in accordance with one or more available protocols or standards (e.g., CDMA, TDMA, GSM, voice-over IP, voice-over WiFi, other). According to some embodiments, the remote terminal 110 is capable of sending and receiving text messages in accordance with one or more available protocols or standards (e.g., Short Message Service (SMS)). The foregoing components of the remote terminal 110 reside in a housing 134.

Each of the foregoing components of the remote terminal 110 may be of any suitable construction and arrangement. Suitable apparatus and software for forming the remote terminal 110 will be readily apparent to those of ordinary skill in the art upon reading the description herein.

The remote terminal 110 may be provided with suitable computer readable program code to perform the operational steps described herein. The processor of the remote terminal 110 may include suitable computer readable program code in the form of software and/or firmware to generate output signals to the display 140 and the speaker 124, to receive signals from the keypad 120 and the microphone 126, to generate and receive signals to/from the wireless transceiver, and to process all such signals and associated data as needed. Various of the code and functionality described in relation to the processor of the remote terminal 110 can be allocated to other components and/or further processors.

Many conventional mobile terminals include the foregoing components of the remote terminal 110 and/or other suitable components and may be employed in systems and operations in accordance with the present invention without modification. The applicable functionality of such devices is generally known to those skilled in the art.

FIG. 3 is a block diagram of exemplary embodiments of the customer sales information provider system 100 and the CSIPC server 200 and illustrates systems, methods, and computer program products in accordance with the present invention. The CSIPC server 200 includes at least one processor 210. The processor 210 communicates with the memory 214 via an address/data bus 218. The processor 210 can be any commercially available or custom microprocessor and may be a plurality of distributed processors. The memory 214 is representative of the overall hierarchy of memory devices containing the software and data used to implement the functionality of the CSIPC server 200. The memory 214 can include, but is not limited to, the following types of devices: cache, ROM, PROM, EPROM, EEPROM, flash memory, SRAM, and DRAM.

As shown in FIG. 3, the memory 214 may include several categories of software and data used in the CSIPC server 200: the operating system 216; the application programs 220; the input/output (I/O) device drivers 250; and data 240.

The application programs 220 may include a payment history collection and maintenance module 222, a communication module 224, a customer lookup module 226, an internal customer information retrieval module 230, an external customer information retrieval module 232, a customer rating and term determining module 234, and an activity reporting module 236. The functionality of the foregoing application modules will be discussed in greater detail below.

The data 240 may include internal customer information data 242 and customer credit data 246. The data 242, 246 may be obtained from one or more of the modules 222, 224, 226, 230, 232, 234, 236 or otherwise sourced. The content of the data 242, 246 will be discussed in greater detail below.

As will be appreciated by those of skill in the art, the operating system 216 may be any operating system suitable for use with a data processing system, such as OS/2, AIX or OS/390 from International Business Machines Corporation, Armonk, N.Y., WindowsXP, WindowsCE, WindowsNT, Windows95, Windows98 or Windows2000 from Microsoft Corporation, Redmond, Wash., PalmOS from Palm, Inc., MacOS from Apple Computer, UNIX, FreeBSD, or Linux, proprietary operating systems or dedicated operating systems, for example, for embedded data processing systems.

The I/O device drivers 250 typically include software routines accessed through the operating system 216 by the application programs 220 to communicate with devices such as I/O data port(s), data storage 240 and certain memory 214 components. The application programs 220 are illustrative of the programs that implement the various features of the CSIPC server 200 and preferably include at least one application that supports operations according to embodiments of the present invention. Finally, the data 240 represents the static and dynamic data used by the application programs 220, the operating system 216, the I/O device drivers 250, and other software programs that may reside in the memory 214.

While the present invention is illustrated, for example, with reference to the modules 222, 224, 226, 230, 232, 234, 236 being application programs in FIG. 3, as will be appreciated by those of skill in the art, other configurations may also be utilized while still benefiting from the teachings of the present invention. For example, the modules 222, 224, 226, 230, 232, 234, 236 may also be incorporated into the operating system 216, the I/O device drivers 250 or other such logical division of the CSIPC server 200. Thus, the present invention should not be construed as limited to the configuration of FIG. 3, which is intended to encompass any configuration capable of carrying out the operations described herein.

The processor 210 includes at least one communication link to an external device for receiving a request from a user and for providing customer sales information to the user. As shown, the processor 210 includes a plurality of communication links L1, L2, L3 and L4. Fewer or greater links may be used. As discussed in more detail below, the links L3 and L4 provide communication between the processor 210 and each of the communications network 160 and the computer network 170. The computer network 170 is in turn connected to the communications network 160 via a communication link L6. The remote terminal 110 is connected to the communications network 160 via communication link L5, and thereby to the processor 210 directly or through the computer network 170.

The link L1 provides two-way communication between the processor 210 and the ECRA system 150. The link L1 may be enabled in any suitable manner. For example, the link L1 may include a computer network and/or a communications network such as a PSTN.

The ECRA system 150 may be any suitable external credit rating agency system of the type that collects and maintains financial and other suitable information relating to consumers or businesses, evaluates and/or compiles such information, and provides credit information including a credit rating or score for a consumer or business (referred to herein as “external credit rating information”) on demand. The ECRA system 150 may require the formation of an account and/or the payment of a subscription, transaction and/or other fee. The information collected and used by the ECRA system 150 in the determination of credit ratings may be publicly available and/or only privately available. Such information may include, for a given consumer or business, records of current and past indebtedness, payment history, legal judgments against the consumer or business, etc. Suitable external credit rating agency systems are well known to those of skill in the art and include, by way of example only, Dun & Bradstreet and/or Equifax. For example, Dun & Bradstreet may be used to obtain client information for a small business customer, and Equifax may be used to obtain credit information for a new business or a previously non-paying customer with approval from the business owner to access the business owner's personal credit history.

The link L2 provides communication between the processor 210 and the local terminal 112. As discussed above, the local terminal 112 may serve as the requester terminal according to some embodiments of the present invention. The local terminal 112 may be a computing device having its own processor that is configured to communicate with the processor 210 via the link L2. For example, the local terminal 112 may be a pervasive computing or communication device. The local terminal 112 may be connected to the processor 210 directly or via a computer network such as an intranet (computers connected within a particular organization, company, coalition, or group) or a Virtual Private Network (VPN). Alternatively, the local terminal 112 may be a suitable output device (e.g., a display) and a suitable input device (e.g., a keyboard) each suitably connected to the processor 210 by the link L2.

The link L3 provides communication between the processor 210 and the computer network 170. The computer network 170 can be a local area network or a wide area network and may include an intranet (computers connected within a particular organization, company, coalition, or group), an extranet, a Virtual Private Network (VPN) or other such mechanism for allowing a plurality of data processing systems with respective outputs to communicate. According to some embodiments, the computer network 170 is or includes a global computer network. According to some embodiments, the global computer network is or includes the Internet. According to some embodiments, the global computer network is or includes the World Wide Web.

The communication link L3 to the computer network 170 is illustrative of various suitable communications mechanisms that may allow the processor 210 to communicate over a computer network. Such a communications link L3 may be provided, for example, by a network interface of a data processing system in communication with the processor 210. Typical network interfaces may include Ethernet, Token Ring or other such direct connections to a computer network provided, typically, by network interface card (NICs) or may be provided by, for example, a modem, including cable modems, Digital Subscriber Loop (DSL) modems, including ADSL and sDSL modems, wireless modems, or conventional telephone modems which provides communications to a computer network.

The link L4 provides communication between the processor 210 and the communications network 160. The communications network 160 may be of any suitable configuration. According to some embodiments, the communications network is a public switched telephone network (PSTN).

Where the remote terminal 110 employed is a wireless communication device as described above, the communications network 160 may include a wireless communications network such as those commonly employed for cellular radiotelephone systems. The communications network 160 may include one or more base stations each including a radiotelephone transceiver. The base station(s) may be served by a mobile telephone switching office (MTSO). The MTSO may in turn be operatively connected to the PSTN via a landline, for example. The wireless remote terminal 110 is adapted to transmit wireless signals (preferably radio signals) to the base station(s), and thereby to the processor 210 via the communications network 160.

Alternatively or additionally, the communications network 160 may include a satellite communications network and include one or more transmission satellites. In this case, the wireless remote terminal 110 may be a satellite telephone adapted to transmit wireless signals (preferably radio signals) to the satellite(s). The signals may be relayed by the transmission satellite via radio signals to the processor 210 directly or through a wireless communication network.

The remote terminal 110 may be enabled to communicate with the processor 210 by one or both of two alternative communication paths and methods. The remote terminal 110 may communicate with the processor 210 through the communications network 160 only (i.e., via links L5 and L4). For example, the remote terminal 110 may establish and use a telephone dial-up modem connection with the processor 210. The link L5 may be wireless or via a landline. Alternatively, the remote terminal 110 may communicate with the computer network 170 via the communications network 160 (i.e., via the links L5 and L6), and thereby with the processor 210 through the computer network 170 (i.e., via link L3). Again, the link L5 may be wireless or via a landline.

As discussed above, according to some embodiments the remote terminal 110 is a wireless communication device and the communications network 160 is a wireless communications network. As further noted above, the computer network 170 may be a global computer network such as the Internet and, according to more particular embodiments, the World Wide Web. According to some embodiments, the computer network 170 is a global computer network and the communications network 160 is a wireless communications network.

As will be appreciated from the description herein, one or more of the foregoing communication links to the processor 210 may be temporary, omitted or inoperative depending on the functionality to be provided and the methods to be executed in accordance with the present invention. For example, in embodiments wherein the ECRA system 150 is not accessed, the communication link between the ECRA system 150 and the processor 210 may be omitted. Furthermore, additional or alternative communication links may be provided. For example, the processor 210 may have communication links to multiple ECRA systems, multiple communications networks 160, multiple computer networks 170, etc.

The requester may initiate a request by inputting a text message (e.g., a telephone number) into the remote terminal 110, which message is transmitted to the processor 210 as described above. The customer sales information can be generated and displayed in the display 122 in a text and/or graphic format. For example, as shown in FIG. 2, the customer sales information can be presented textually.

The CSIPC server 200 may provide an electronically accessible and navigable electronic page or template configured to allow the requester to input information to be provided to the processor 210 and to generate text or graphics representing the customer sales information. As discussed above, the request and response may be transmitted via the computer network 170 and, in particular, the computer network 170 may be the Internet. In this case, the electronic page may be a web page. In certain embodiments, the processor 210 can provide the customer sales information as web pages that may be predefined and stored at a local device. Such web pages may also be dynamically generated to provide the customer sales information as it becomes available. The web pages may be Hypertext Markup Language (HTML) common gateway interface (CGI) web pages. The web pages may also be or include Java scripts, Java applets or the like which may execute at the processor 210. As will be appreciated by those of skill in the art, other mechanisms for communicating between a web server and a client may also be utilized. For example, other markup languages, such as Wireless Markup Language (WML) or the like, for communicating between the local processor and the requester using an output display may be used.

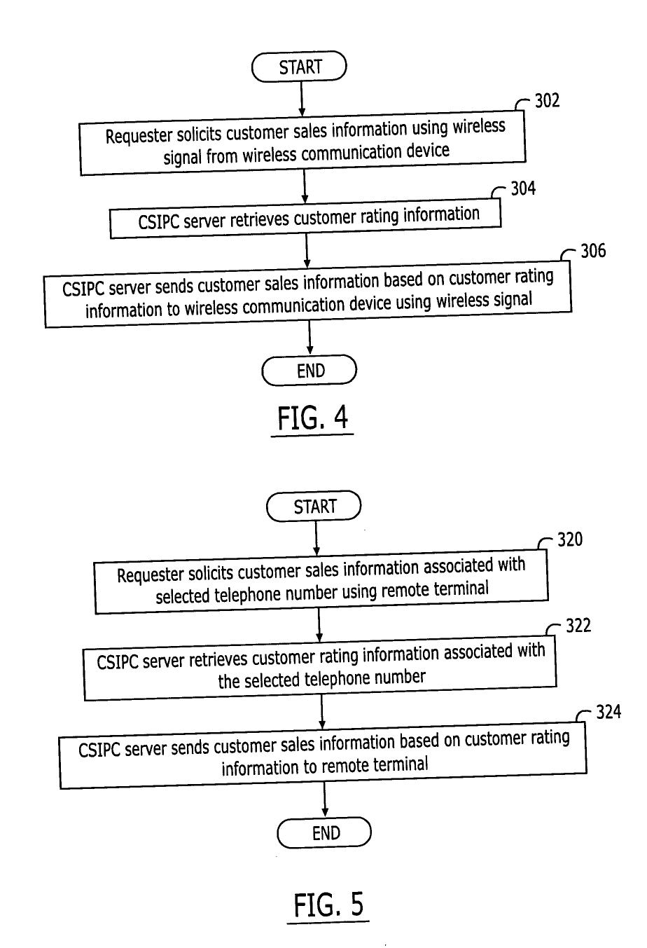

FIG. 4 illustrates operations that may be used to carry out embodiments of the present invention. In accordance with these embodiments, a requester solicits customer sales information for a selected customer from the CSIPC server 200 using a wireless signal from a wireless communication device 110 to the communications network 160 (Block 302). The wireless communications network 160 relays the request to the CSIPC server 200. Responsive to the request, the CSIPC server 200 retrieves customer rating information associated with the selected customer (Block 304). The CSIPC server 200 then sends customer sales information based on the customer rating information to the wireless communication device 110 (Block 306). More particularly, the customer sales information may be sent through the wireless communications network 160, which relays the customer sales information to the wireless communication device 110 via wireless signal.

FIG. 5 illustrates operations that may be used to carry out further embodiments of the present invention. In accordance with these embodiments, a requester solicits customer sales information associated with a selected telephone number from the CSIPC server 200 using a remote terminal 110 (Block 320). The telephone number corresponds to a unique customer. Responsive to the request, the CSIPC server 200 retrieves customer rating information associated with the selected telephone number (Block 322). More particularly, the CSIPC server 200 may identify the customer associated with the telephone number and retrieve credit rating information corresponding to that customer. The CSIPC server 200 then sends customer sales information based on the customer rating information to the remote terminal 110 (Block 324). These operations may be modified and/or supplemented in the manners described above and below.

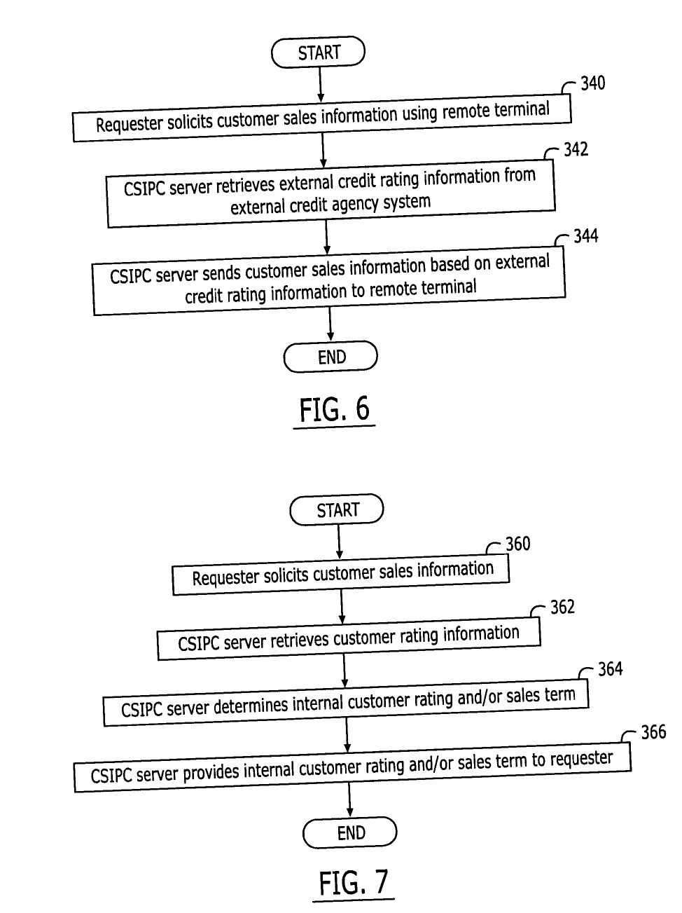

FIG. 6 illustrates operations that may be used to carry out further embodiments of the present invention. In accordance with these embodiments, a requester (who may be a member of a business organization) solicits customer sales information for a selected customer from the CSIPC server 200 (which may be under the control of the business organization) using a remote terminal 110 (Block 340). Responsive to the request, the CSIPC server 200 retrieves external credit rating information associated with the selected customer from the ECRA system 150 (Block 342). The external credit rating information may be, for example, a credit rating or score from an external credit rating agency. The CSIPC server 200 then sends customer sales information based on the external credit rating information to the remote terminal 110 (Block 344). The customer sales information may consist of only the external credit rating information. These operations may be modified and/or supplemented in the manners described above and below.

FIG. 7 illustrates operations that may be used to carry out further embodiments of the present invention. In accordance with these embodiments, a requester solicits customer sales information from the CSIPC server 200, for example, using a remote terminal 110 or a local terminal 112 (Block 360). Responsive to the request, the CSIPC server 200 retrieves customer rating information associated with the selected customer (Block 362). Using the customer rating information, the CSIPC server 200 automatically determines an internal customer rating or sales term (Block 364). The CSIPC server 200 then provides the internal customer rating or sales term to the requester at the terminal 110, 112 (Block 366). The internal customer rating may be, for example, an overall credit rating for the customer. The sales term may be, for example, a maximum authorized sale amount or required terms of sale. According to some embodiments, the customer rating or sales term is based on both internal customer information and external credit rating information, as discussed herein.

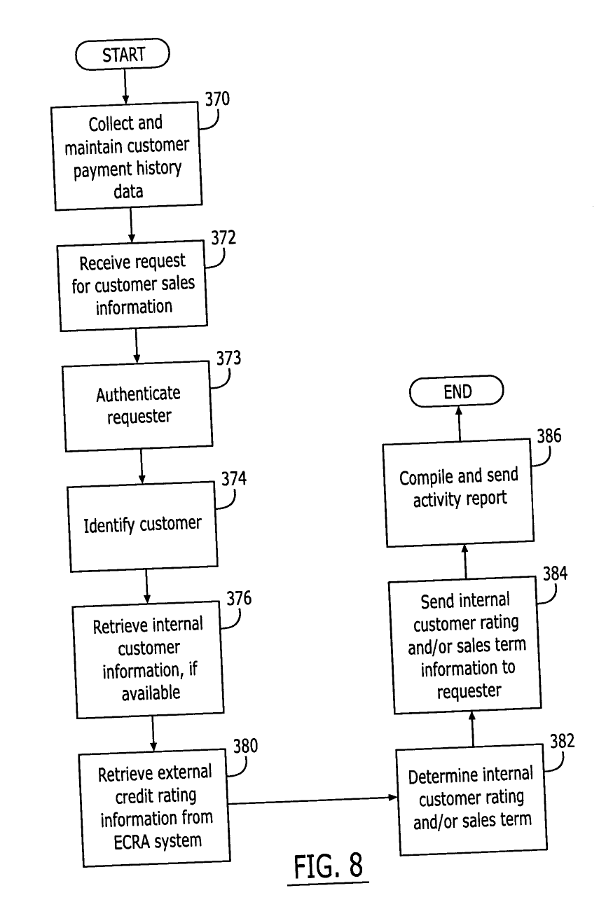

Further aspects of and modifications to the foregoing embodiments will be further appreciated from consideration of embodiments described below with reference to FIG. 8.

FIG. 8 illustrates operations that may be used to carry out further embodiments of the present invention. The payment history collection and maintenance module 222 of the CSIPC server 200 collects and maintains records of payment history of customers (Block 370). The customers may be customers of an organization such as a vendor whose goods/services are being offered by a sales representative, or an affiliated entity. The payment history may be a history of the payments made and/or due to the vendor (or affiliated entity). For example, the vendor may be a publisher of a business directory and the customer may have had a past advertisement in the business directory for which payments were due. Additionally or alternatively, the vendor or affiliated entity may be a telephone service provider and the customer may have purchased telephone service from the vendor for which payments were due. The payment history data is saved in the internal customer information data 242. The internal customer information data 244 may include further information relating to the customer such as customer profile information, details of past advertising by the customer, and/or details of past products purchased from the vendor by the customer.

The requester sends a request for customer sales information to the CSIPC server 200 (Block 372). The request may take the form of a specific request for an internal customer rating and/or sales term. The communication module 224 may enable reception and processing of the request message. The request may be sent using any of the apparatus and methods described above. The requester may first place a call to or access an electronic page generated by the CSIPC server 200, and thereafter enter and send the request. The request may designate a customer identifier such as the customer's name or account number. According to some embodiments, as discussed above, the customer identifier may be or include a telephone number associated with the customer.

The CSIPC server 200 may authenticate the requester to confirm that the requester (e.g., sales representative) is authorized to access the information (Block 373). The authentication step may include any suitable method such as comparing a username and password from the requester to a table of authorized users.

The customer lookup module 226 accesses the internal customer information data 242 to identify the customer corresponding to the request (Block 374). For example, where the request is or includes a telephone number or account number, the customer lookup module 226 identifies the customer name, tax identification number or the like corresponding to the telephone or account number. The customer name or similar identification may be required in order to access information from the ECRA system 150.

The internal customer information retrieval module 230 retrieves the internal customer information data 242 to access the records of payment history, if any, to the vendor associated with the selected customer (Block 376). The module 230 may also access other internal customer information such as the customer address, a customer contact name, one or more category designations that have been assigned to the customer (e.g. account closed or suspended) and/or information relating to past advertising or product purchase by the customer.

The external customer information retrieval module 232 retrieves an external credit rating from the ECRA system 150 (Block 380). The module 232 may access the ECRA system 150 in the manner discussed hereinabove. Typically, the CSIPC server 200 will submitted a request to the ECRA system 150 for a credit rating associated with the selected customer. The customer is identified in the request in a manner recognizable by the ECRA system 150 (e.g., name, tax identification number, or any other suitable identifier). Means and methods for accessing and retrieving credit ratings from external credit agencies (e.g., commercial credit rating agencies) are well known and will not be described herein in detail. The ECRA system 150 responds by sending data to the CSIPC server 200 including the external credit rating (e.g., one or more credit rating scores) for the customer and any other related information. The external credit rating may be saved in the customer credit data 246.

The internal customer rating and term determining module 234 then determines an internal customer rating and/or one or more sales terms (Block 382). The module 382 may determine the internal customer rating and/or sale term(s) using the external credit rating and/or the internal customer information (including the customer payment history).

According to some preferred embodiments, the module 234 determines the internal customer rating and/or sale term(s) using both the external credit rating and the internal customer information when both are available. In this way, the CSIPC server 200 may provide a customer rating and/or sale term(s) based on a combination of internal and externally sourced information.

Moreover, the module 234 may employ a formula, algorithm and/or rule set that incorporates policies of the vendor. For example, the module 234 may employ a formula that weights internal and external customer information in accordance with reliability, length of time the customer has been a customer of the vendor, the nature of the goods/services offered, etc. Accordingly, the module 234 may automatically calculate and/or evaluate the internal and external credit information such that the CSIPC server 200 emulates the consideration and judgment provided by a credit rating manager or otherwise effects the policies of the vendor.

The internal customer rating may be a rating or score, such as “good”, “neutral” or “poor”, or a numerical designation (e.g., from “1” to “10”). The requester may have pre-existing instructions or authorization to offer goods/services to the customer in accordance with the internal customer credit rating. For example, the vendor policy may include standing authorization to extend $5000 of credit for a “good” customer and only $1000 for a “poor” customer.

The sales term(s) may include one or more terms or conditions of sale. Such terms or conditions may include a maximum amount of credit, a maximum sale amount, a minimum down payment required, an applicable interest rate to be charged, a payment schedule (e.g., monthly, annually, etc.), surcharges to be applied, a maximum periodic (e.g., monthly) payment, etc.

The communication module 226 then sends the internal customer rating and/or sales term(s) to the terminal 110, 112 where it is displayed for viewing by the requester (Block 384). The CSIPC server 200 may also send further information to the terminal 110, 112 for display, such as the external credit rating, biographical customer information, etc. The CSIPC server 200 may send the information using any of the apparatus and methods described above.

The requester may use the customer rating and/or sales term(s) to determine the terms of sale, and even whether a sale to the customer is authorized. The information provided may enable the sales representative to offer the customer alternative sales arrangements.

Optionally, the activity reporting module 236 may compile and send (automatically or upon request) a report of the requester's activities to the terminal 110, 112 or another suitable display (Block 386). The report may include a listing of the customers for which credit ratings have been requested and the internal customer ratings/sales term(s) issued by the CSIPC server 200. The report may be issued daily, weekly or monthly, for example.

In the methods wherein the CSIPC server 200 retrieves external credit rating information from the ECRA system 150, the CSPIC server 200 may access the ECRA system 150 and retrieve the information on demand or substantially realtime. Alternatively, the CSPIC server 200 may access and retrieve the information from the ECRA system 150 on a periodic basis, for example, daily, weekly, monthly or quarterly.

Methods and apparatus according to the present invention may substantially facilitate efficient and effective use of customer sales information in customer negotiations and the like. Where a remote terminal such as a wireless communication device is enabled, the user (e.g., a sales representative) can request and receive the information while away from a central location and, more particularly, while at or traveling to a customer's facility.

Methods and apparatus according to the present invention may substantially facilitate efficient and effective use of customer sales information by automatically evaluating available external credit rating, internal payment history and/or other internal data to calculate or otherwise generate an overall internal customer rating and/or sales terms. In this manner, a human credit manager or committee is not required, and the delays associated therewith can be avoided. As a result, the sales representative may negotiate a sale on a realtime basis.

In the drawings and specification, there have been disclosed embodiments of the invention and, although specific terms are employed, they are used in a generic and descriptive sense only and not for purposes of limitation, the scope of the invention being set forth in the following claims. The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method for providing customer sales information, the method comprising:
a) sending a request for customer sales information associated with a customer from a member of a business organization to a customer sales information processing and communication (CSIPC) server associated with the business organization using a terminal that is remote from the CSIPC server;
b) retrieving external credit rating information associated with the customer from an external credit rating agency (ECRA) system using the CSIPC server, wherein the ECRA system is not associated with the organization; and
c) sending the customer sales information from the CSIPC server to the terminal, wherein the customer sales information is based on the external credit rating information.

2. The method of claim 1 wherein the terminal is a wireless communication device and the request is sent to the CSIPC server using a wireless signal.

3. The method of claim 1 wherein the terminal and the CSIPC server communicate via a public switched telephone network (PSTN).

4. The method of claim 1 wherein the terminal and the CSIPC server communicate via the Internet.

5. The method of claim 1 wherein the customer sales information is sent from the CSIPC server to the terminal as a textual and/or graphical message.

6. The method of claim 5 further comprising displaying the textual and/or graphical message on a display of the terminal.

7. The method of claim 1 wherein:
a) the request includes a first customer identifier corresponding to the customer;
b) the method further comprises associating the first customer identifier with a second customer identifier using the CSIPC server; and
c) the step of retrieving the external credit information includes providing the second customer identifier to the ECRA system.

8. The method of claim 7 wherein the first customer identifier is a telephone number.

9. The method of claim 8 wherein the customer sales information includes the name of the customer.

10. The method of claim 1 wherein:
a) the method further comprises retrieving internal customer information associated with the customer by the business organization from a database of the CSIPC server; and
b) the customer sales information is also based on the internal customer information.

11. The method of claim 10 wherein the internal customer information includes payment history information.

12. The method of claim 10 further comprising determining an internal customer rating based on both the external credit rating and the internal customer information, wherein the customer sales information includes the internal customer rating.

13. The method of claim 10 further comprising determining a sales term based on at least one of the external credit rating and the internal customer information, wherein the customer sales information includes the sales term.

14. The method of claim 13 wherein the sales term includes at least one of a maximum allowed sale amount and a required down payment.

15. The method of claim 1 wherein:
a) the terminal is a wireless communication device and the request is sent to the CSIPC server using a wireless signal;
b) the request includes a telephone number corresponding to the customer;
c) the method further comprises associating the telephone number with a customer identifier using the CSIPC server;
d) the step of retrieving the external credit information includes providing the customer identifier to the ECRA system;
e) the method further comprises retrieving payment history information associated with the customer by the business organization from a database of the CSIPC server; and
f) the customer sales information is also based on the payment history information.

16. The method of claim 15 further comprising determining an internal customer rating based on both the external credit rating and the internal customer information, wherein the customer sales information includes the internal customer rating.

17. The method of claim 15 further comprising determining a sales term based on at least one of the external credit rating and the internal customer information, wherein the customer sales information includes the sales term.

18. The method of claim 17 wherein the sales term includes at least one of a maximum allowed sale amount and a required down payment.

19. The method of claim 1, wherein the requester is a sales representative for a vendor of business directory advertisements, and further comprising offering to sell the customer a business directory advertisement.

20. The method of claim 1 including authenticating the member of the business organization to confirm that the member is authorized to access the customer sales information.

21. A method for providing customer sales information, the method comprising:
a) sending a request for customer sales information associated with a customer from a member of a business organization to a customer sales information processing and communication (CSIPC) server associated with the business organization using a wireless signal from a wireless communication device;
b) retrieving customer rating information associated with the customer using the CSIPC server; and
c) sending the customer sales information to the wireless communication device from the CSIPC server using a wireless signal, wherein the customer sales information is based on the customer rating information.

22. The method of claim 21 wherein the wireless communication device and the CSIPC server communicate via a public switched telephone network (PSTN).

23. The method of claim 21 wherein the wireless communication device and the CSIPC server communicate via the Internet.

24. A method for providing customer sales information, the method comprising:
a) sending a request for customer sales information from a member of a business organization to a customer sales information processing and communication (CSIPC) server associated with the business organization using a terminal that is remote from the CSIPC server, the request including a telephone number;
b) retrieving customer rating information associated with the telephone number using the CSIPC server; and
c) sending the customer sales information to the terminal from the CSIPC server, wherein the customer sales information is based on the customer rating information.

25. The method of claim 24 wherein the customer sales information includes the name of a customer associated with the telephone number in a database of the CSIPC server.

26. A method for providing customer sales information, the method comprising:
a) sending a request for customer sales information associated with a customer from a requester to a customer sales information processing and communication (CSIPC) server;
b) retrieving customer rating information associated with the customer using the CSIPC server; and
c) automatically determining a sales term using the CSIPC server, wherein the sales term is based on the customer rating information; and
d) sending the sales term to the requester from the CSIPC server.

27. The method of claim 26 wherein the sales term includes at least one of a maximum allowed sale amount and a required down payment.

28. The method of claim 26 wherein the credit rating information includes an external credit rating from an external credit rating agency (ECRA) system.

29. The method of claim 26 wherein:
a) the method further comprises retrieving internal customer information associated with the customer by a business organization associated with the CSIPC server from a database of the CSIPC server; and
b) the customer rating information includes the internal customer information.

30. The method of claim 29 wherein the internal customer information includes payment history information.

31. The method of claim 30 wherein the credit rating information further includes an external credit rating from an external credit rating agency (ECRA) system.

32. A method for providing customer sales information, the method comprising:
a) sending a request for customer sales information associated with a customer to a customer sales information processing and communication (CSIPC) server associated with a business organization;
b) retrieving internal customer information associated with the customer by the business organization from a database of the CSIPC server;
c) retrieving external credit rating information associated with the customer from an external credit rating agency (ECRA) system;
d) automatically determining an internal customer rating using the CSIPC server, wherein the internal customer rating is based on both the external credit rating and the internal customer information; and
e) sending the internal customer rating to the requester from the CSIPC server.

33. The method of claim 32 wherein the internal customer information includes payment history information.

34. A system for providing customer sales information, the system comprising:
a) a customer sales information processing and communication (CSIPC) server associated with a business organization; and
b) a terminal that is remote from the CSIPC server and operable to send a request for customer sales information associated with a customer from a member of the business organization to the CSIPC server;
c) wherein the CSIPC server is configured to:
receive the request from the terminal;
retrieve external credit rating information associated with the customer from an external credit rating agency (ECRA) system, wherein the ECRA system is not associated with the organization; and
send the customer sales information to the terminal, wherein the customer sales information is based on the external credit rating information.

35. A system providing customer sales information, the system comprising:
a) a customer sales information processing and communication (CSIPC) server associated with a business organization; and
b) a wireless communication device operable to send a request for customer sales information associated with a customer from a member of the business organization to the CSIPC server using a wireless signal;
c) wherein the CSIPC server is configured to:
receive the request from the wireless communication device;
retrieve customer rating information associated with the customer using the CSIPC server; and
send the customer sales information to the wireless communication device using a wireless signal, wherein the customer sales information is based on the customer rating information.

36. A system for providing customer sales information, the system comprising:
a customer sales information processing and communication (CSIPC) server associated with a business organization, wherein the CSIPC server is configured to:
receive a request for customer sales information associated with a customer from a member of the business organization using a terminal that is remote from the CSIPC server, the request including a telephone number;
retrieve customer rating information associated with the telephone number; and
send the customer sales information to the terminal, wherein the customer sales information is based on the customer rating information.

37. A system for providing customer sales information, the system comprising:
a customer sales information processing and communication (CSIPC) server, wherein the CSIPC server is configured to:
receive a request from a requester for customer sales information associated with a customer;
retrieve customer rating information associated with the customer;
automatically determine a sales term, wherein the sales term is based on the customer rating information; and
send the sales term to the requester.

38. A system for providing customer sales information, the system comprising:
a customer sales information processing and communication (CSIPC) server associated with a business organization, wherein the CSIPC server is configured to:
receive a request from a requester for customer sales information associated with a customer;
retrieve internal customer information associated with the customer by the business organization from a database of the CSIPC server;
retrieve external credit rating information associated with the customer from an external credit rating agency (ECRA) system;
automatically determine an internal customer rating, wherein the internal customer rating is based on both the external credit rating and the internal customer information; and
send the internal customer rating to the requester.

39. A computer program product for providing customer sales information, the computer program product comprising:
a computer readable storage medium having computer readable program code embodied in the medium, the computer readable program code comprising:
a) computer readable program code configured to send a request for customer sales information associated with a customer from a member of a business organization to a customer sales information processing and communication (CSIPC) server associated with the business organization using a terminal that is remote from the CSIPC server;
b) computer readable program code configured to retrieve external credit rating information associated with the customer from an external credit rating agency (ECRA) system using the CSIPC server, wherein the ECRA system is not associated with the organization; and
c) computer readable program code configured to send the customer sales information from the CSIPC server to the terminal, wherein the customer sales information is based on the external credit rating information.

40. A computer program product for providing customer sales information, the computer program product comprising:
a computer readable storage medium having computer readable program code embodied in the medium, the computer readable program code comprising:
a) computer readable program code configured to send a request for customer sales information associated with a customer from a member of a business organization to a customer sales information processing and communication (CSIPC) server associated with the business organization using a wireless signal from a wireless communication device;
b) computer readable program code configured to retrieve customer rating information associated with the customer using the CSIPC server; and
c) computer readable program code configured to send the customer sales information to the wireless communication device from the CSIPC server using a wireless signal, wherein the customer sales information is based on the customer rating information.

41. A computer program product for providing customer sales information, the computer program product comprising:
a computer readable storage medium having computer readable program code embodied in the medium, the computer readable program code comprising:
a) computer readable program code configured to receive a request for customer sales information sent from a member of a business organization to a customer sales information processing and communication (CSIPC) server associated with the business organization using a terminal that is remote from the CSIPC server, the request including a telephone number;
b) computer readable program code configured to retrieve customer rating information associated with the telephone number using the CSIPC server; and
c) computer readable program code configured to send the customer sales information to the terminal from the CSIPC server, wherein the customer sales information is based on the customer rating information.

42. A computer program product for providing customer sales information, the computer program product comprising:
a computer readable storage medium having computer readable program code embodied in the medium, the computer readable program code comprising:
a) computer readable program code configured to receive a request for customer sales information associated with a customer sent from a requester to a customer sales information processing and communication (CSIPC) server;
b) computer readable program code configured to retrieve customer rating information associated with the customer using the CSIPC server; and
c) computer readable program code configured to automatically determine a sales term using the CSIPC server, wherein the sales term is based on the customer rating information; and
d) computer readable program code configured to send the sales term to the requester from the CSIPC server.

43. A computer program product for providing customer sales information, the computer program product comprising:
a computer readable storage medium having computer readable program code embodied in the medium, the computer readable program code comprising:
a) computer readable program code configured to receive a request for customer sales information associated with a customer sent to a customer sales information processing and communication (CSIPC) server associated with a business organization;
b) computer readable program code configured to retrieve internal customer information associated with the customer by the business organization from a database of the CSIPC server;
c) computer readable program code configured to retrieve external credit rating information associated with the customer from an external credit rating agency (ECRA) system;
d) computer readable program code configured to automatically determine an internal customer rating using the CSIPC server, wherein the internal customer rating is based on both the external credit rating and the internal customer information; and
e) computer readable program code configured to send the internal customer rating to the requester from the CSIPC server.
